(19) United States
(12) Patent Application Publication
(10) Pub. No.: US 2025/0333633 A1
(43) Pub. Date: Oct. 30, 2025

(54) SYNERGISTIC APPROACH TO DEVELOP RESILIENT CEMENT SYSTEMS FOR LONG TERM WELLBORE INTEGRITY OF OIL, GAS AND GEOTHERMAL WELLS

(71) Applicant: ARAMCO SERVICES COMPANY, Houston, TX (US)

(72) Inventors: Ashok Santra, The Woodlands, TX (US); Kenneth Johnson, Houston, TX (US); Roland Martinez, Houston, TX (US)

(73) Assignee: ARAMCO SERVICES COMPANY, Houston, TX (US)

(21) Appl. No.: 18/650,772

(22) Filed: Apr. 30, 2024

(51) Int. Cl. C09K 8/487

(52) U.S. Cl. CPC C09K 8/487

(57) ABSTRACT

A cement slurry includes water, a cement precursor, a sliding ring polymer, and an additional polymer. A cured cement composition, such as a cement sheath, can be prepared from the cement slurry. A method for providing a cement sheath in a wellbore includes introducing the cement slurry to an area between a casing and a formation rock of the wellbore and curing the cement slurry injected to the area between the casing and the formation rock of the wellbore, thereby forming the cement sheath in the wellbore.

### BACKGROUND

Cement slurries are used in the oil and gas industry for cementing oil and gas wells. Cement holds the casing in place and prevents fluid migration between subsurface formations. Primary cementing includes pumping cement down a casing and into an annulus between the formation and the casing (or between casings). Secondary cementing, or remedial cementing, is performed to repair primary cementing issues. Cements used in the oil and gas industry must be able to withstand the extreme temperatures, pressures and chemical environments encountered in hydrocarbon-bearing formations.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a cement slurry that includes water, a cement precursor, a sliding ring polymer, and an additional polymer.

In another aspect, embodiments disclosed herein relate to a cured cement composition prepared from the cement slurry including water, the cement precursor, the sliding ring polymer, and the additional polymer.

In yet another aspect, embodiments disclosed herein relate to a method for providing a cement sheath in a wellbore. The method includes introducing a cement slurry to an area between a casing and a formation rock of the wellbore and curing the cement slurry injected to the area between the casing and the formation rock of the wellbore, thereby forming the cement sheath in the wellbore. The cement slurry includes water, a cement precursor, a polyrotaxane polymer, and an additional copolymer.

Other aspects and advantages of the claimed subject matter will be apparent from the following description and the appended claims.

### BRIEF DESCRIPTION OF DRAWINGS

FIG. 1A is a schematic representation of deformation capability of a cement having a high Young's modulus.

FIG. 1B is a schematic representation of deformation capability of a cement having a low Young's modulus.

FIG. 2 is a block flow diagram of an embodiment method of making a cement slurry.

FIG. 3 is a schematic depiction of a formation in accordance with one or more embodiments of the present disclosure.

FIG. 4 is a stress versus axial strain (deformation) graph for different cement systems A-E as presented in Table 2.

FIG. 5 is a plot of the magnitude of axial strain (deformation versus Young's modulus for cement systems A-E as presented in Table 2.

### DETAILED DESCRIPTION

Oil and gas well cementing is an important operation during drilling and completion of oil wells. The main purpose of a primary cement job is to support the casing and provide effective zonal isolation for the life of the well. To achieve this objective, the entire wellbore annulus should be filled with a competent cement/sealant that meets both short and long-term well requirements. The two major phases in the life of an oil, gas, and geothermal well are (1) well construction and (2) operation. During the well construction phase, constantly changing stresses around the borehole caused by fluctuating fluid gravity inside the wellbore influence residual stresses in the cement sheath. During the well operation phase, subsidence, depletion, and human intervention (pressure testing, perforating, fracturing, production, or injection) can cause stresses on the sealant.

The cement sheath must maintain well integrity behind the casing and provide long-term zonal isolation to ensure safety and prevent environmental problems. The cements placed in the annulus between the casing and the formations (or between casings) experiences stress at wellbore conditions, especially as pressure and temperatures change or cycle with the movement of fluids and equipment. As such, cracking from compression, traction, or microannulus formation can occur. Physical degradation of the cement over a period can also cause deterioration in both the mechanical structure of the cement and the chemical adhesion the cement has to the casing, tubing or wellbore wall. Such degradation can negatively impact production, increase costs, and reduces the margin of safely operating the well.

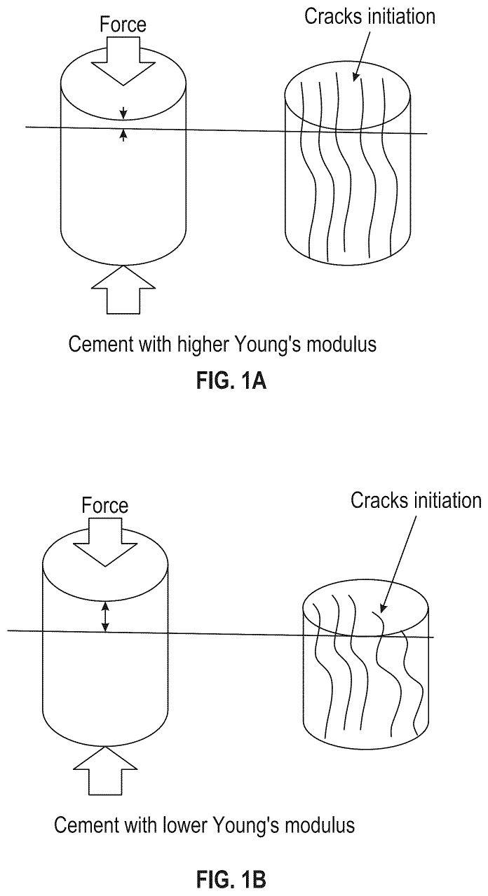

Failure of the cement sheath is most often caused by pressure- or temperature-induced stresses inherent in well operations. In such instances, axial deformation of the cement sheath may occur during which the cement sheath may be compressed such that the length of the cement sheath along the axial plane changes due to pressure- or temperature-induced stresses inherent in well operations. In particular, cracking can occur at early axial strain deformation for cements with a higher Young's modulus (e.g., the cement system of FIG. 1A), indicates a lower resiliency and durability under downhole thermal and/or mechanical stressful situations as compared to a cement system having a lower Young's modulus as shown in FIG. 1B. This lower resiliency and durability can manifest as failure in cement integrity (e.g., cracking), which can create a path for formation fluids to enter the annulus, which can pressurize the well and render it unsafe to operate. Failure can also cause premature water production that can limit the economic life of the well. Consequently, if the cement sheath fails during its active life, the objective of producing hydrocarbons safely and economically may not be met. The cement sheath should have optimum properties so it can withstand the stresses from well operations.

It is generally understood based on data obtained from well history and experimental studies, such as finite elemental analysis (FEA), that the long-term mechanical integrity of wellbore cement sheath depends on the mechanical properties of the cement sheath, such as Young's modulus, tensile strength and resiliency. In particular, long-lasting mechanical properties of a set cement system should have a Young's modulus of 1.5×10⁶ psi or less and a higher resiliency. A higher resiliency of the cement sheath may refer to the magnitude of deformation that the cement can withstand at an increased stress level before it fails. Thus, the higher resiliency a cement sheath has, the longer lasting the cement sheath may be. For example, a high resiliency cement sheath will survive a longer period of time in a wellbore as compared to a cement sheath with low resiliency when subjected to multiple high stress cycles. The Young's modulus of a highly resilient cement sheath having a composition in accordance with one or more embodiments may be at least about 25% less than the Young's modulus of a cement sheath prepared from a neat cement.

The present disclosure relates to compositions and methods for providing a cement sheath that has an improved capability to withstand stress over time. Specifically, a sliding ring polymer and an additional polymer are blended into a cement slurry and distributed throughout the cement matrix during the cement curing process. The cured cement obtained from the cement slurry may have a higher resiliency as compared to a cement having only one of a sliding ring polymer or an additional polymer or a cement without the sliding ring polymer and the additional polymer.

### Cement Slurry Composition

In one aspect, embodiment cement slurry compositions include an aqueous fluid, a cement precursor material, a sliding ring polymer, and an additional polymer. Embodiment cement slurries may include one or more of silica flour, a cement retarder, a dispersant, and a fluid loss control agent.

Embodiment slurries include a cement precursor material. The cement precursor material may be any suitable material that when mixed with water can be cured into a cement. The cement precursor material may be hydraulic or nonhydraulic. A hydraulic or non-hydraulic cement precursor material may be chosen based on the desired application of the cement slurry of the present disclosure. In some embodiments, the cement slurry comprises a hydraulic cement precursor. Hydraulic cements precursors are materials that refer to a mixture of limestone, clay and gypsum burned together under extreme temperatures that may begin to harden instantly or within a few minutes while in contact with water.

In some specific embodiments, the cement precursor material may be Portland cement precursor, such as Class A Portland Cement, Class B Portland Cement, Class C Portland Cement, Class G Portland Cement or Class H Portland Cement. Portland cement precursor is a hydraulic cement precursor (cement precursor material that not only hardens by reacting with water but also forms a water-resistant product) produced by pulverizing clinkers, which contain hydraulic calcium silicates and one or more of the forms of calcium sulfate as an inter-ground addition. In other embodiments, the cement precursor material may be Saudi cement precursor, which is a combination of Portland cement precursor and crystalline silica. Crystalline silica is also known as quartz.

In some embodiments of the cement precursor composition, a non-hydraulic-cement precursor is used. A non-hydraulic cement precursor material refers to a mixture of lime, gypsum, plasters and oxychloride. A non-hydraulic cement precursor may take longer to harden or may require drying conditions for proper strengthening, but often is more economically feasible.

In some other embodiments of the cement precursor composition, the cement precursor may include additional materials. The cement precursor material may include, but is not limited to, calcium hydroxide, silicates, oxides, belite (Ca₂SiO₅), alite (Ca₃SiO₄), tricalcium aluminate (Ca₃Al₂O₆), tetracalcium aluminoferrite (Ca₄Al₂Fe₂O₁₀), brownmilleriate (4CaOAl₂O₃·Fe₂O₃), gypsum (CaO₄·2H₂O), sodium oxide, potassium oxide, limestone, lime (calcium oxide), hexavalent chromium, calcium aluminate, silica sand, silica flour, hematite, manganese tetroxide, and combinations thereof. The cement precursor material may include, but is not limited to, siliceous fly ash, calcareous fly ash, slag cement, silica fume, quartz, any known cement precursor material or combinations of any of these.

In some embodiments, the cement slurry includes silica flour. Silica flour is a finely ground crystalline silica with a molecular formula of SiO₂ and with a grain size ranging from about 1 to about 500 microns, such as from 10 to 500 microns, such as from 10 to 100 microns, such as from 10 to 80 microns, such as from 10 to 50 microns, such as from 10 to 20 microns, such as from 20 to 100 microns, such as from 20 to 80 microns, such as from 20 to 50 microns, such as from 50 to 100 microns, such as from 50 to 80 microns, and such as from 80 to 100 microns. Where used, silica flour may be present in the cement slurry in an amount in the range of from about 25% to about 75% by weight of cement precursor. Embodiment cement slurries may include retarder(s) in an amount having a lower limit of any one of 25, 30, 35, 40, 50, and 55% by weight of the cement precursor and an upper limit of any one of 50, 60, 65, 70, and 75% by weight of cement precursor, where any lower limit may be used in combination with any mathematically compatible upper limit.

Cement slurries of one or more embodiments include an aqueous fluid. The aqueous fluid includes water. The water may be distilled water, deionized water, tap water, fresh water from surface or subsurface sources, production water, formation water, natural and synthetic brines, brackish water, natural and synthetic sea water, black water, brown water, gray water, blue water, potable water, non-potable water, other waters, and combinations thereof, that are suitable for use in a wellbore environment. In one or more embodiments, the water used may naturally contain contaminants, such as salts, ions, minerals, organics, and combinations thereof, as long as the contaminants do not interfere with curing of the cement slurry and the mechanical properties of a cement cured from the cement slurry.

Embodiment slurries may include water in an amount sufficient to cure the previously described cement precursor. In some embodiments, the slurry may contain the aqueous fluid in an amount in a range from about 30 to 320% by weight of the cement precursor. Embodiment cement slurries or both may include an aqueous fluid in an amount having a lower limit of any one of 30, 35, 40, 45, 50, 75, 100, and 200% by weight of the cement precursor and an upper limit of any one of 75, 200, 225, 250, 275, 300, and 320% by weight of the cement precursor, where any lower limit may be used in combination with any mathematically compatible upper limit.

Embodiment slurries include a sliding ring polymer. The sliding ring polymer may be a polyrotaxane polymer. Sliding ring polymers in accordance with one or more embodiments may be as described in U.S. Patent Application No. US 2020/0325070, which is incorporated by reference herein in its entirety. In some embodiments, the sliding ring polymer is ROTAMACH, which may be obtained from Saudi Arabian Oil Company. Embodiment cement slurries may include a sliding ring polymer in an amount having a lower limit of any one of 0.025, 0.05, 0.1, 0.25, 0.5, 0.75, 1.0, 2.0, 2.5 or 3.0% by weight of cement precursor and an upper limit of any one of 5.5, 5.0, 4.5, 4.0 or 3.5 wt. % by weight of cement precursor, where any lower limit may be used in combination with any mathematically compatible upper limit.

Embodiment slurries include an additional polymer. The additional polymer may be a thermoplastic polymer. The additional polymer may be a copolymer of styrene and butadiene. In some embodiments, the styrene-butadiene copolymer includes at least 65% butadiene units and less than 35% styrene units. For example, the styrene-butadiene copolymer includes 70% butadiene units and 30% styrene units. In particular embodiments, the additional polymer includes a Calprene® 411 copolymer (e.g., Calprene® 411M), which may be obtained from Dynasol. In some embodiments, the cement slurry may contain from about 0.05 to about 35.0 wt % of additional polymer by weight of cement precursor. Embodiment additional polymers may have a lower limit of 0.05, 0.10, 0.25, 0.5, 1.0, 2.0, 2.5, 3.0, 5.0, 7.5, 10, 15, 20 or 25.0 wt. % by weight of cement precursor and an upper limit of 35.0, 30.0, 25.0, 20, 15, 12.5, 10, or 7.5 wt. % by weight of cement precursor, where any lower limit may be used in combination with any mathematically compatible upper limit.

The cement slurry of one or more embodiments may include one or more retarder(s) or retarding agent(s). The retarder(s) may include, but are not limited to, lignosulfonates, organic acids, phosphonic acid derivatives, synthetic polymers (e.g. copolymers of 2-acrylamido-2-methylpropane sulfonic acid (“AMPS”) and unsaturated carboxylic acids including but not limited to acrylic acid), inorganic borate salts, and combinations thereof. In some embodiments, the cement retarder includes one or more compounds selected from the group consisting of a sodium lignosulfonate, a calcium lignosulfonate, a copolymer of acrylic acid (AA) and 2-acrylamido-2-methylpropane sulfonic acid (AMPS), and combinations thereof. The retarder(s) may include retardant commercially available as PCR-3 synthetic retarder from Economy® Polymers & Chemicals. Where used, the retarder(s) may be present in the cement slurry, in a cured cement composition, or both an amount in the range of from about 0.009% to about 10.2% by weight of cement precursor. Embodiment cement slurries may include retarder(s) in an amount having a lower limit of any one of 0.009, 0.1, 0.25, 0.5, 0.75, 1.0, 2.0, 2.5, 3.0, or 5.0% by weight of cement precursor and an upper limit of any one of 5.0, 5.5, 6.0, 7.0, 7.5, 8.0, 9.0, 9.5, 9.9, 10.0, or 10.2% by weight of cement precursor, where any lower limit may be used in combination with any mathematically compatible upper limit.

In one or more embodiments, the cement slurry includes one or more dispersant(s). The dispersant(s) may control the rheology of the cement slurry. The dispersant(s) may include, but are not limited to, a lignosulfonate and a polyacrylic acid polymer (PAA). The dispersant(s) may include a cement dispersant commercially available as SC-9 from Economy® Polymers & Chemicals. Where used, the dispersants may be present in cement slurries in an amount in the range of from about 0.009% to about 5.2% by weight of cement precursor. Embodiment cement slurries may include dispersant(s) in an amount having a lower limit of any one of 0.009, 0.1, 0.25, 0.5, 0.75, 1.0, 2.0, 2.5, or 3.0% by weight of cement precursor and an upper limit of any one of 3.0, 3.5, 4.0, 4.5, 5.0, or 5.2% by weight of cement precursor, where any lower limit may be used in combination with any mathematically compatible upper limit.

The cement slurry of one or more embodiments may include one or more fluid loss control agent(s). The fluid loss control agent(s) may include, but are not limited to, hydroxyethylcellulose and a terpolymer of AMPS, AA, and N,N-dimethyl acetamide (NNDMA). In some embodiments, the fluid loss control agent(s) includes one or more compounds selected from the group consisting of hydroxyethylcellulose, a terpolymer of AMPS, AA, and N,N-dimethyl acetamide (NNDMA), and combinations thereof. The fluid loss control agent(s) may include fluid loss control agent commercially available as Polytrol® FL 24 from BASF. Where used, the fluid loss control agent(s) may be present in the cement slurry in an amount in the range of from about 0.009% to about 5.2% by weight of cement precursor. Embodiment cement slurries may include fluid loss control agent(s) in an amount having a lower limit of any one of 0.009, 0.1, 0.25, 0.5, 0.75, 1.0, 2.0, 2.5, or 3.0% by weight of cement precursor and an upper limit of any one of 3.0, 3.5, 4.0, 4.5, 5.0, or 5.2% by weight of cement precursor, where any lower limit may be used in combination with any mathematically compatible upper limit.

### Cured Cement Composition

In one aspect, embodiment compositions relate to a cured cement matrix having a sliding ring polymer and additional polymer distributed throughout the cement matrix. Embodiment cured cements are made by curing the previously-described cement slurries. Cured cement compositions of one or more embodiments may be capable of axial deformation without cracking when compressive stress is applied. In contrast, a cured cement prepared in the absence of the sliding ring polymer, the additional polymer, or both has a propensity to crack under compressive stress, formation pressures, formation temperatures, or combinations thereof.

The cured cement composition of one or more embodiments may have an increased ability to withstand deformation pressures as compared to a cured cement prepared in the absence of the sliding ring polymer, the additional polymer, or both. In some embodiments, the cured cement composition can axially deform to a greater degree under stress without cracking as compared to a cured cement prepared in the absence of the sliding ring polymer, the additional polymer, or both. For example, the cured cement composition according to one or more embodiments may be capable of withstanding 10% or more, 12.5% or more, 15% or more, 20% or more, or 25% or more axial stress as compared to a cured cement prepared in the absence of the sliding ring polymer, the additional polymer, or both. The cured cement having a composition in accordance with one or more embodiments may be able to withstand axial stress at a value greater than a cured cement prepared in the absence of the sliding ring polymer, the additional polymer, or both, where the value is in a range having a lower limit of any one of 10%, 12.5%, 15%, 25%, 30%, 35%, and 40% and an upper limit of any one of 45%, 50%, 55%, 60% 70%, 80%, 90%, 95%, and 99%, where any lower limit can be paired with any mathematically compatible upper limit.

Embodiment cured cement compositions may include a sliding ring polymer in an amount sufficient to improve mechanical properties of the cement. In some embodiments, the cement may contain from about 0.025 to about 5.5 wt. % of sliding ring polymer by weight of cement (bwoc). Embodiment sliding ring polymers may have a lower limit of 0.025, 0.05, 0.1, 0.25, 0.5, 0.75, 1.0, 2.0, 2.5 or 3.0 wt. % bwoc and an upper limit of 5.5, 5.0, 4.5, 4.0 or 3.5 wt. % bwoc, where any lower limit may be used in combination with any mathematically compatible upper limit.

Embodiment cured cement compositions may include an additional polymer in an amount sufficient to improve mechanical properties of the cement. In some embodiments, the cement may contain from about 0.05 to about 35.0 wt. % of additional polymer by weight of cement (bwoc). Embodiment additional polymers may have a lower limit of 0.05, 0.10, 0.25, 0.5, 1.0, 2.0, 2.5, 3.0, 5.0, 7.5, 10, 15, 20 or 25.0 wt. % bwoc and an upper limit of 35.0, 30.0, 25.0, 20, 15, 12.5, 10, or 7.5 wt. % bwoc, where any lower limit may be used in combination with any mathematically compatible upper limit.

Where used, silica flour may be present in the cured cement composition in an amount in the range of from about 25% to about 75% bwoc. Embodiment cement slurries may include silica flour in an amount having a lower limit of any one of 25, 30, 35, 40, 50, and 55% bwoc and an upper limit of any one of 50, 60, 65, 70, and 75% bwoc, where any lower limit may be used in combination with any mathematically compatible upper limit.

Embodiment cured cement compositions may include one or more fluid loss control agent(s) in an amount in a range from about 0.05 to about 5.5 wt. % of additional by weight of cement (bwoc). Embodiment fluid loss control agent(s) may have a lower limit of 0.05, 0.1, 0.25, 0.5, 0.75, 1.0, 2.0, 2.5 or 3.0 wt. % bwoc and an upper limit of 5.5, 5.0, 4.5, 4.0 or 3.5 wt. % bwoc, where any lower limit may be used in combination with any mathematically compatible upper limit.

Embodiment cured cement compositions may include one or more dispersant(s) in an amount in a range from about 0.05 to about 5.5 wt. % of additional by weight of cement (bwoc). Embodiment dispersant(s) may have a lower limit of 0.05, 0.1, 0.25, 0.5, 0.75, 1.0, 2.0, 2.5 or 3.0 wt. % bwoc and an upper limit of 5.5, 5.0, 4.5, 4.0 or 3.5 wt. % bwoc, where any lower limit may be used in combination with any mathematically compatible upper limit.

Embodiment cured cement compositions may include one or more cement retarder(s) in an amount in a range from about 0.05 to about 5.5 wt. % of additional by weight of cement (bwoc). Embodiment cement retarder(s) may have a lower limit of 0.05, 0.1, 0.25, 0.5, 0.75, 1.0, 2.0, 2.5 or 3.0 wt. % bwoc and an upper limit of 5.5, 5.0, 4.5, 4.0 or 3.5 wt. % bwoc, where any lower limit may be used in combination with any mathematically compatible upper limit.

Embodiment cured cement compositions may realize improved mechanical properties as compared to cements that do not include both an additional polymer and a sliding ring polymer. Such improvements may include a decrease in unconfined compressive strength, a decrease in compressive strength, and a decrease in Young's modulus when compared with cements that do not include embodiment both a sliding ring polymer and an additional polymer. For example, the Young's modulus of a cured cement having a composition in accordance with one or more embodiments may be at least about 25% less than the Young's modulus of a cured cement prepared in the absence of the sliding ring polymer, the additional polymer, or both. The Young's modulus of a cured cement having a composition in accordance with one or more embodiments may be at least 25%, at least 28% less than, at least 30% lower than, at least 35% lower than, at least about 40% lower than, at least 45% lower than, or at least 50% less than the Young's modulus of a cured cement prepared from a cured cement prepared in the absence of the sliding ring polymer, the additional polymer, or both. The Young's modulus of a cured cement having a composition in accordance with one or more embodiments may be a value less than the Young's modulus of a cured cement prepared in the absence of the sliding ring polymer, the additional polymer, or both and in a range having a lower limit of any one of 25%, 28%, 30%, 35%, and 40% and an upper limit of any one of 45%, 50%, 55%, 60% 70%, 80%, 90%, 95%, and 99%, where any lower limit can be paired with any mathematically compatible upper limit. These improved properties may reduce physical deformation of embodiment cured cement compositions (e.g., cement sheaths) when exposed to changes in temperature and pressure, such as those encountered in subterranean formations.

### Method of Making a Cement Slurry

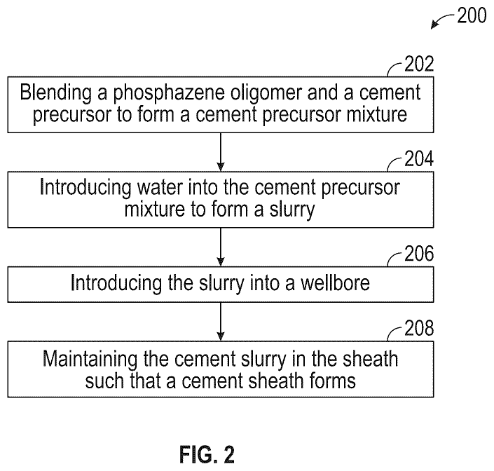

In one aspect, embodiments disclosed here relate to a method of making the previously described cement slurry. FIG. 2 is a block flow diagram of an embodiment method of making a slurry 200. The method may include blending a sliding ring polymer and an additional polymer with a cement precursor and to form a cement precursor mixture 202. If present, a fluid loss control agent, a dispersant, or a retardant may also be blended with the sliding ring polymer, the additional polymer, and the cement precursor to form a cement precursor mixture. In some embodiments, dry additives are pre-blended with a powder cement precursor. The dry additives and cement precursor may be blended using a pneumatic transfer method between two silos 3 to 4 times to form a dry blend.

The dry blend may then be mixed with water along with any remaining additives in liquid form are then mixed at a rig site to form a cement slurry using a large-scale real-time mixer. The cement slurry may then be pumped downhole immediately after formation. Embodiment methods may further include introducing water into the cement precursor mixture 204. The water may be introduced at a mixing speed in a range having a lower limit of any one of 3000, 3500, 3800, and 4000 RPM (revolutions per minute) and an upper limit of any one of 4000, 4200, 4500, 4800, and 5000 RPM, where any lower limit can be paired with any mathematically compatible upper limit. In some embodiments, the amount of water added to the dry blend is determined based on a target density for the cement slurry. After the water has been introduced into the cement precursor mixture, the resultant slurry may be mixed for a time and at a mixing speed suitable for obtaining a homogeneous slurry. Embodiment mixing times may have a lower limit of 10, 20, 30, 35 or 40 seconds, and an upper limit of 60, 55, 50 or 45 seconds, where any lower limit may be used in combination with any mathematically compatible upper limit. Embodiment mixing speeds may have a lower limit of 500, 1,000, 2,000, 5,000 or 8,000 RPM, and an upper limit of 20,000, 18,000, 15,000, or 12,000 RPM, where any lower limit may be used in combination with any mathematically compatible upper limit. In some embodiments, the slurry may be mixed for about 35 seconds at about 12,000 RPM. In some embodiments, water may be introduced to the dry blend at a mixing speed of about 4000 RPM (revolutions per minute) for 15 seconds. The slurry may then be mixed at 12,000 RPM for 35 seconds.

### Method of Cementing a Formation

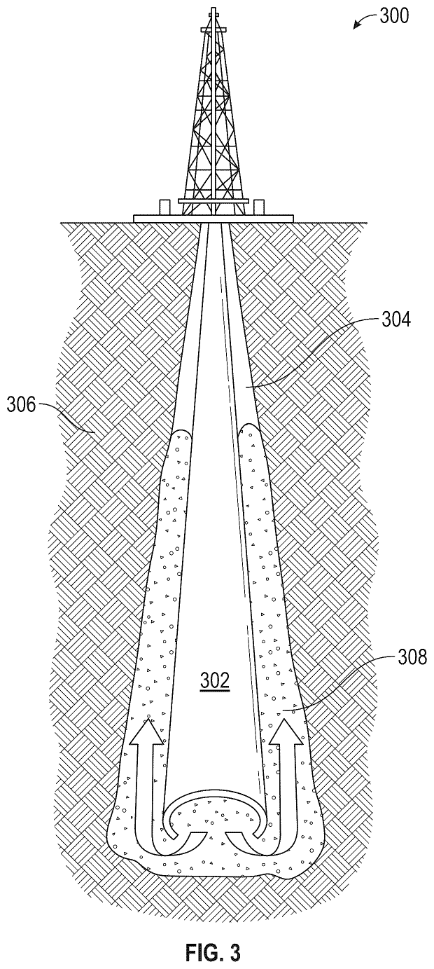

In one aspect, embodiments disclosed relate to a method of forming a cement sheath in a wellbore. Embodiment methods include introducing the previously described slurry composition into a wellbore 206. The composition may include the previously described sliding ring polymer and additional polymer evenly distributed throughout the cement slurry. FIG. 3 is a schematic depiction of cementing a formation 300. The slurry 308 may be pumped downhole through a casing 302. The slurry 308 is then pushed up into an annulus 304 between the formation 306 and the casing 302. The direction of cement flow is indicated by arrows (not labeled). Once the cement has been introduced into the formation, the method may further include maintaining the cement slurry in the wellbore such that a sheath forms. The cement sheath may have the previously-described embodiment sliding ring polymer and additional polymer evenly distributed throughout the cement matrix.

As previously described, embodiment methods may include introducing the previously-described slurry into a wellbore 206 (e.g., introducing the previously described slurry to an area between a casing and a formation rock of the wellbore) and maintaining the cement slurry in the wellbore such that a cured cement sheath forms 208.

Embodiment methods may include maintaining the cement slurry such that the cement is cured in the wellbore. Embodiment slurries may be cured for any suitable time, temperature and pressure in order to cure the cement. Embodiment cements may begin curing upon initial contact with water. Embodiment curing times may be from several hours to several days. Embodiment curing times may have a lower limit of 3, 4, 5, 10, 12 or 24 hours, and an upper limit of 90, 50, 30, 7, 5, 4, 3 or 2 days, where any lower limit may be used in combination with any mathematically compatible upper limit. One of ordinary skill in the art understand that such conditions may vary due to differences in compositions of the embodiment cement slurries and downhole conditions.

Embodiment cement slurries may cure under formation conditions, such as temperatures in a range of from about 25 to about 260° C. and pressures of from ambient pressure to about 45,000 psi. Embodiment formation temperatures may have a lower limit of 25, 50, 65 or 75° C., and an upper limit of 260, 200, 150 or 95° C., where any lower limit may be used in combination with any mathematically compatible upper limit. Embodiment formation pressures may have a lower limit of 15, 100, 1,000, 3,000 or 5,000 psi, and an upper limit of 45,000, 30,000, 20,000, 15,000 or 10,000 psi, where any lower limit may be used in combination with any mathematically compatible upper limit.

Embodiment cements may be used in various subterranean formations for primary and secondary cementing operations.

### EXAMPLES

The following examples are merely illustrative and should not be interpreted as limiting the scope of the present disclosure.

Five cement slurries compositions were designed according to Table 1 shown below. Each of the cement slurries was mixed in accordance with API RP 10B2, which is the Recommended Practice for Testing Well Cements. For each cement slurry composition of Table 1, water was introduced to a dry blend of ingredients at mixing speed of about 4000 RPM (revolutions per minute) for 15 seconds. Then, the slurry was mixed at 12,000 RPM for 35 seconds.

TABLE 1
Slurry compositions

| Slurry # | A | B | C | D | E |
|---|---|---|---|---|---|
| Materials | Cement | Cement + | Cement + | Cement + 15% | Cement + 15% |
| | only | 0.5% RM | 15% EM | EM + 0.25% RM | EM + 0.5% RM |
| | (gm) | (gm) | (gm) | (gm) | (gm) |
| Cement | 595.49 | 594.32 | 603.05 | 602.45 | 601.85 |
| Class G | | | | | |
| Silica Flour | 208.42 | 208.01 | 211.07 | 210.86 | 210.65 |
| FL-24 | 4.22 | 4.21 | 4.27 | 4.27 | 4.26 |
| SC-9 | 2.4 | 2.4 | 2.43 | 2.43 | 2.43 |
| PCR-3 | 1 | 1 | 1.01 | 1.01 | 1.01 |
| ROTAMACH | 0 | 2.97 | 0 | 1.51 | 3.01 |
| (RM) | | | | | |
| Calprene ® | 0 | 0 | 90.46 | 90.37 | 90.28 |
| 411M (EM) | | | | | |
| Water | 296.24 | 296 | | 300 | 300 |
| Density | 15.8 ppg | 15.8 ppg | 15.8 ppg | 15.8 ppg | 15.8 ppg |

The materials of Table 1 include Class G cement precursor, silica flour, Polytrol® FL 24 fluid loss control agent from BASF (FL-24), SC-9 cement dispersant from Economy® Polymers & Chemicals, PCR-3 cement retardant from Economy® Polymers & Chemicals, ROTAMACH sliding ring polymer from Saudi Aramco (RM), and styrene-butadiene copolymer Calprene® 411M copolymer (EM) from Dynasol.

Testing was performed on multiple 1 inch by 2 inch cylindrical cement specimens, which were cured at 300° F. and 3,000 psi for 7 days. Triaxial mechanical properties (e.g., Young's modulus for each specimen) were measured using a New England Research (NER 300) instrument with 1500 psi confining pressure and at 100 F.

TABLE 3
Young's modulus and compressive strength
for the different cement systems

| | | Young's | Compressive | % Young's |
|---|---|---|---|---|
| | | modulus | strength | Modulus |
| Slurry # | System | (psi) | (psi) | reduction |
| A | Control (Cement only) | 2.32 × 10⁶ | 12328 | — |
| B | Cement + 0.5% RM | 2.17 × 10⁶ | 10878 | 6.5 |
| C | Cement + 15% EM | 1.94 × 10⁶ | 8068 | 16.4 |
| D | Cement + 15% | 1.51 × 10⁶ | 7040 | 34.9 |
| | EM + 0.25% RM | | | |
| E | Cement + 15% | 1.29 × 10⁶ | 6515 | 44.4 |
| | EM + 0.5% RM | | | |

Control cement system (system A) with no mechanical properties enhancer was determined to have a high Young's modulus (i.e., 2.32×10⁶ psi) and the lowest capability to axially deform under stress. System B having 0.5% bwoc of sliding ring polymer (ROTAMACH (RM)) has a slightly lower Young modulus and a slightly higher capability to axially deform under stress as compared to system A. System C having 15% bwoc of an additional polymer (i.e., Calprene® 411M) has a Young's modulus of 1.94×10⁶ psi and a slightly higher capability to axially deform under stress as compared to system A.

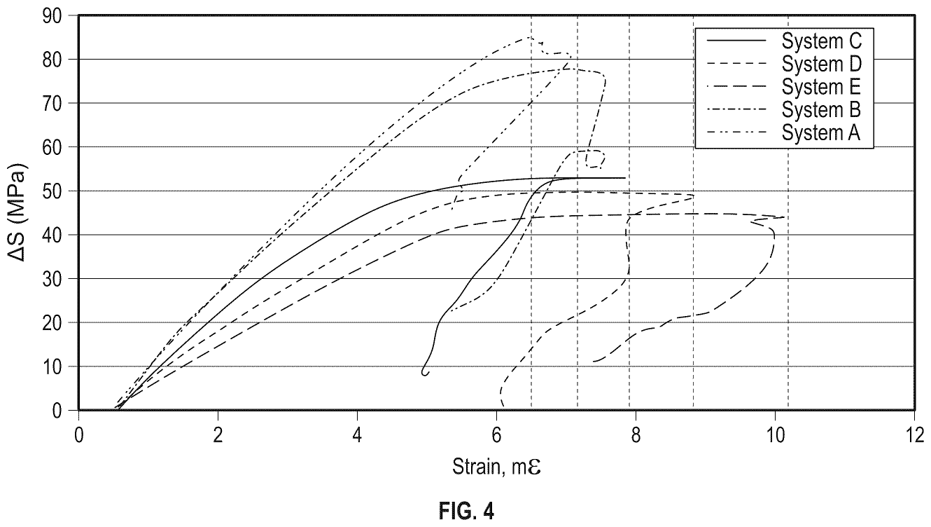

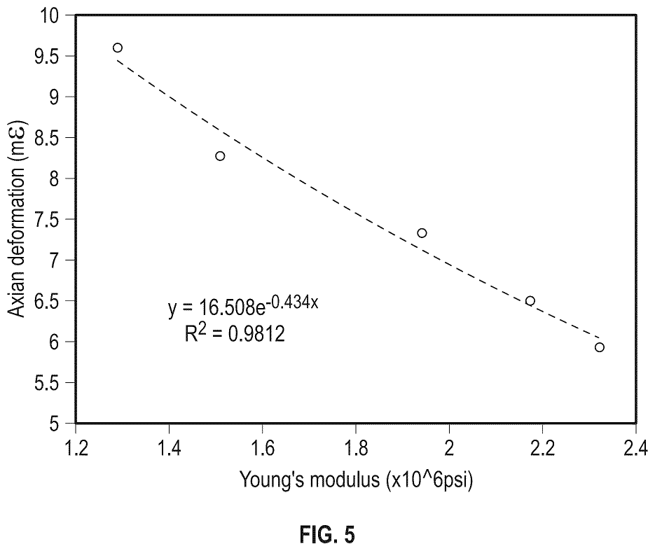

Systems D and E both having a combination of Calprene® 411M and ROTAMACH were determined to have low Young's modulus values as compared to system A. In particular, systems D and E were determined to have Young's modulus values of approximately 1.5×10⁶ psi or less, which indicates a very high capability to axially deform under stress as compared to system A. FIG. 4 is a stress versus axial strain (deformation) graph for different cement systems of Table 2. FIG. 5 is a plot of the magnitude of axial strain (deformation versus Young's modulus for Systems A-E.

As shown in Table 2 and FIGS. 4 and 5, systems D and E were determined to have a higher capacity for deformation as demonstrated by the high strain values achieved. Thus, the lower Young's modulus of systems D and E as compared to systems A-C indicates that a cement sheath of such system have the capability to survive higher stresses for a longer period of time. Thus, the combined approach of including an additional polymer (e.g., Calprene® 411M) and a relatively small amount of a sliding ring polymer (e.g., ROTAMACH) can bring excellent synergy to provide resilient mechanical properties in cured cements needed for the longer term zonal isolation of the oil, gas and geothermal wells for the life of the well.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

1. A cement slurry comprising:
water;
a cement precursor;
from 30 to 70 wt. % of silica flour by weight of the cement precursor;
a sliding ring polymer comprising a polyrotaxane polymer;
an additional polymer; and
from 0.1 to 10 wt. % of a cement retarder by weight of the cement precursor, wherein the cement retarder comprises one or more compounds selected from the group consisting of a sodium lignosulfonate, a calcium lignosulfonate, a copolymer of acrylic acid (AA) and 2-acrylamido-2-methylpropane sulfonic acid (AMPS), and combinations thereof; and
wherein the sliding ring polymer and the additional polymer are present in the cement slurry as a mixture of polymers.

2. The cement slurry of claim 1, wherein the additional polymer is a thermoplastic styrene-butadiene copolymer.

3. The cement slurry of claim 2, wherein the additional polymer is present in an amount from 0.1 to 30% by weight of the cement precursor.

4. The cement slurry of claim 2, wherein the styrene-butadiene copolymer comprises 70% butadiene units and 30% styrene units.

5. The cement slurry of claim 1, wherein the water, the sliding ring polymer, and the additional polymer are in a range from 35 to 300% by weight of the cement precursor, from 0.05 to 5% by weight of the cement precursor, and 0.1 to 30% by weight of the cement precursor, respectively.

6. (canceled)

7. The cement slurry of claim 1, further comprising from 0.1 to 5% by weight of the cement-precursor of a dispersant, wherein the dispersant comprises one or more compounds selected from the group consisting of a lignosulfonate, a polyacrylic acid polymer, and combinations thereof.

8. The cement slurry of claim 1, further comprising from 0.1 to 5% by weight of the cement-precursor of a fluid loss control agent, wherein the fluid loss control agent comprises one or more compounds selected from the group consisting of hydroxyethylcellulose, a terpolymer of AMPS, AA, and N,N-dimethyl acetamide (NNDMA), and combinations thereof.

9. A cured cement composition prepared from the cement slurry of claim 1.

10. The cured cement composition of claim 9, wherein the cured cement composition has a lower Young's modulus as compared to a cement prepared in the absence of the sliding ring polymer and the additional polymer.

11. The cured cement composition of claim 10, wherein the Young's modulus of the cured cement composition is at least 25% less than the Young's modulus of a cured cement prepared in the absence of the sliding ring polymer, the additional polymer, or both.

12. The cured cement composition of claim 10, wherein a Young's Modulus of the cured cement composition is 1.5×10⁶ psi or less.

13. The cured cement composition of claim 10, wherein the cured cement composition is capable of axial deformation when compressive stress is applied.

14. The cured cement composition of claim 13, wherein the cured cement composition is capable of withstanding 10% or more axial stress as compared to a cured cement prepared in the absence of the sliding ring polymer, the additional polymer, or both.

15. The cured cement composition of claim 10, wherein a compressive strength of the cured cement composition is 8000 psi or less.

16. A method for providing a cement sheath in a wellbore, the method comprising:
introducing a cement slurry to an area between a casing and a formation rock of the wellbore, wherein the cement slurry comprises:
water;
a cement precursor;
from 30 to 70 wt. % of silica flour by weight of the cement precursor;
a sliding ring polymer comprising a polyrotaxane polymer;
an additional polymer; and
from 0.1 to 10 wt. % of a cement retarder by weight of the cement precursor, wherein the cement retarder comprises one or more compounds selected from the group consisting of a sodium lignosulfonate, a calcium lignosulfonate, a copolymer of acrylic acid (AA) and 2-acrylamido-2-methylpropane sulfonic acid (AMPS), and combinations thereof,
wherein the sliding ring polymer and the additional polymer are present in the cement slurry as a mixture of polymers,
curing the cement slurry injected to the area between the casing and the formation rock of the wellbore, thereby forming the cement sheath in the wellbore.

17. The method of claim 16, further comprising preparing the cement slurry, wherein the preparation of the cement slurry comprises:
mixing the cement precursor, the sliding ring polymer comprising the polyrotaxane polymer, the additional polymer, the silica flour, the cement retarder, and the water.

18. The method of claim 16, wherein a Young's Modulus of the cement sheath is 1.5×10⁶ psi or less.

19. The method of claim 16, wherein the cement sheath is capable of axial deformation when compressive stress is applied.

20. The method of claim 16, wherein the method further comprises:
prior to introducing the cement slurry to the wellbore, mixing the cement precursor, the sliding ring polymer comprising the polyrotaxane polymer, the additional polymer, the silica flour, and the cement retarder to form a dry blend; and
adding water to the dry blend to form the cement slurry.
